(19) United States
(12) Patent Application Publication
(10) Pub. No.: US 2012/0106663 A1
(43) Pub. Date: May 3, 2012

(54) METHOD FOR TRANSMITTING DATA

(75) Inventors: Tao ZHANG, Shanghai (CN); Fenglong YU, Shanghai (CN); Wei ZHANG, Shanghai (CN)

(73) Assignee: O2MICRO, INC., Santa Clara, CA (US)

(21) Appl. No.: 13/286,880

(22) Filed: Nov. 1, 2011

(30) Foreign Application Priority Data
Nov. 2, 2010 (CN) 201010532426.3

(51) Int. Cl. H04L 27/00

(52) U.S. Cl. 375/259

(57) ABSTRACT

Embodiments in accordance with the present invention provide a method for transmitting a data frame between a battery management system (BMS) and an associated device. The battery management system is coupled to an associated device via a one-wire bi-directional communication line. The method includes obtaining a control right of the one-wire bi-directional communication line and determining a target device based on a frame header by sending the frame header of a data frame by a source device; sending a specific data byte of the data frame from the source device to the target device; checking whether an acknowledge character from the target device is received by the source device within a predetermined time period; and releasing the control right of the one-wire bi-directional communication line if the acknowledge character is received within the predetermined time period by the source device or otherwise resending the data frame.

### RELATED APPLICATION

This application claims priority to Chinese Patent Application No. 201010532426, titled “Method for Transmitting Data,” filed on Nov. 2, 2010, with the State Intellectual Property Office of the People's Republic of China.

### BACKGROUND

A rechargeable battery is a type of battery which can be recharged by a battery charger. Rechargeable batteries are commonly used as power supplies in various electronic devices, such as cameras, media players, battery-powered toys, etc. Such rechargeable batteries are usually in standard types, such as AA batteries or AAA batteries. If the power of those rechargeable batteries is depleted, the batteries can be charged by standard battery chargers. Because those batteries are relatively small and the charging process is relatively simple, no additional battery management system is needed.

While for others such as electric bicycles, electric tricycles or electric vehicles, they need rechargeable batteries with relatively large capacities because of the heavy weight of the bicycles and vehicles and the need to support enough mileages. More specifically, for example, the power supply system in an electric vehicle generally includes a rechargeable battery for providing power to electrical components in the vehicle, a battery charger for charging the rechargeable battery, a controller powered by the rechargeable battery and for driving the motor and other electrical components. A standard connector for connecting the battery charger or controller to the rechargeable battery has three terminals. However, usually only two terminals among the three are used for transmitting power, and the other one is idle and not in use.

In some electric vehicles, the rechargeable battery pack includes a battery management system (BMS) which can be used to monitor and control the charging and discharging operation, and communicate with the battery charger or the controller. The rechargeable battery pack is coupled to the battery charger or controller via power wires and communication wires. Based on current communication protocols, such as RS232, transferring data involves two communication wires. In other words, if the power supply system of the electric vehicle includes a battery management system, a connector for connecting the battery charger or controller to the rechargeable battery pack has four terminals. As such, a customized connector needs to be used instead of a standard connector, which causes inconvenience to users.

### SUMMARY

Embodiments in accordance with the present invention provide a method for transmitting a data frame between a battery management system (BMS) and an associated device. The battery management system is coupled to an associated device via a one-wire bi-directional communication line. The method includes obtaining a control right of the one-wire bi-directional communication line and determining a target device based on a frame header by sending the frame header of the data frame by a source device; sending a specific data byte of the data frame from the source device to the target device; checking whether an acknowledge character from the target device is received by the source device within a predetermined time period; and releasing the control right of the one-wire bi-directional communication line if the acknowledge character is received within the predetermined time period by the source device and resending the data frame if no acknowledge character is received by the source device within the predetermined time period.

### BRIEF DESCRIPTION OF THE DRAWINGS

Features and advantages of embodiments of the claimed subject matter will become apparent as the following detailed description proceeds, and upon reference to the drawings, wherein like numerals depict like parts, and in which:

FIG. 1 shows a data transmission system, in accordance with one embodiment of the present invention.

FIG. 2 shows data transmission system, in accordance with another embodiment of the present invention.

FIG. 3 shows a flowchart of a method for transmitting data, in accordance with one embodiment of the present invention.

FIG. 4 shows a structure of a data frame, in accordance with one embodiment of the present invention.

FIG. 5 shows the waveform of Bit 1 and Bit 0 in a data frame, in accordance with one embodiment of the present invention.

FIG. 6 shows a first waveform of a sync header in a first data frame and a second waveform of a sync header in a second data frame, in accordance with one embodiment of the present invention.

FIG. 7 shows a third waveform of a sync header in a third data frame and a fourth waveform of a sync header in a fourth data frame, in accordance with one embodiment of the present invention.

FIG. 8 shows a flowchart of sending a data frame, in accordance with one embodiment of the present invention.

FIG. 9 shows a flowchart of receiving a data frame, in accordance with one embodiment of the present invention.

### DETAILED DESCRIPTION

Reference will now be made in detail to the embodiments of the present invention. While the invention will be described in conjunction with these embodiments, it will be understood that they are not intended to limit the invention to these embodiments. On the contrary, the invention is intended to cover alternatives, modifications and equivalents, which may be included within the spirit and scope of the invention as defined by the appended claims.

Furthermore, in the following detailed description of the present invention, numerous specific details are set forth in order to provide a thorough understanding of the present invention. However, it will be recognized by one of ordinary skill in the art that the present invention may be practiced without these specific details. In other instances, well known methods, procedures, components, and circuits have not been described in detail as not to unnecessarily obscure aspects of the present invention.

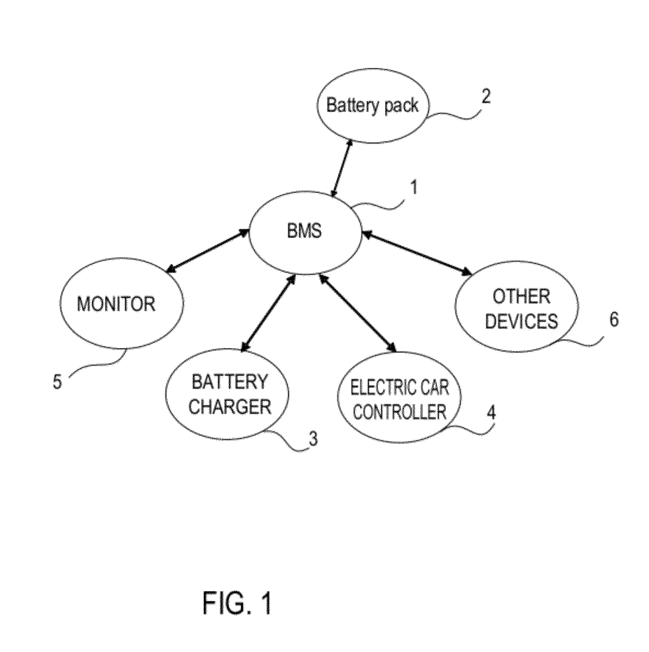

FIG. 1 shows a data transmission system, in accordance with one embodiment of the present invention. As shown in FIG. 1, the system includes a battery management system (BMS) 1 for managing charging and discharging of a battery pack 2, and associated devices including a battery charger 3 for charging the battery pack 2, an electric vehicle controller 4 powered by the battery pack 2 for driving a motor and other electric components in the electric vehicle. In one embodiment, the system can further include a monitor 5, e.g., a computer, for monitoring a status of the battery management system 1 and adjusting the associated parameters of battery management system 1. The system can include other associated devices 6.

To manage the charging and discharging of battery pack 2, the battery management system 1 communicates with associated devices, such as the battery charger 3 and the electric vehicle controller 4. Advantageously, the bi-directional communication between the battery management system 1 and associated devices in an electric vehicle can be achieved by using a single wire.

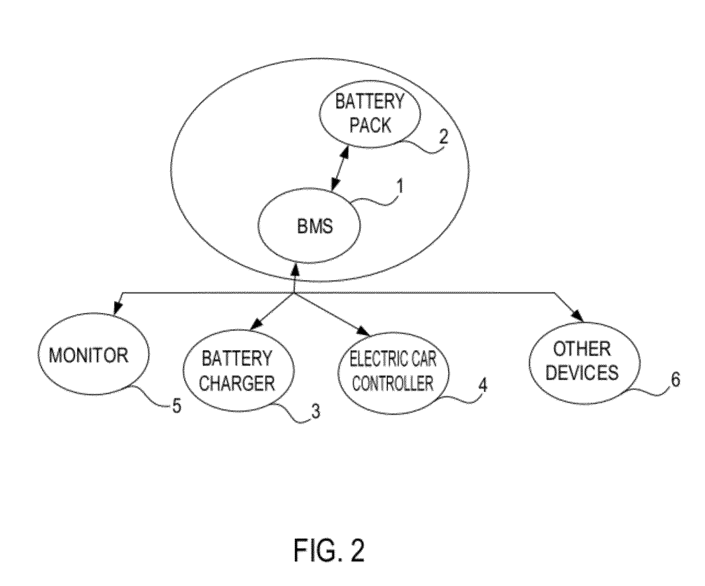

In one embodiment, the battery management system 1 is coupled to each of the devices through a communication line respectively (shown in FIG. 1). In another embodiment, the battery management system 1 is coupled to multiple devices though a data bus (shown in FIG. 2).

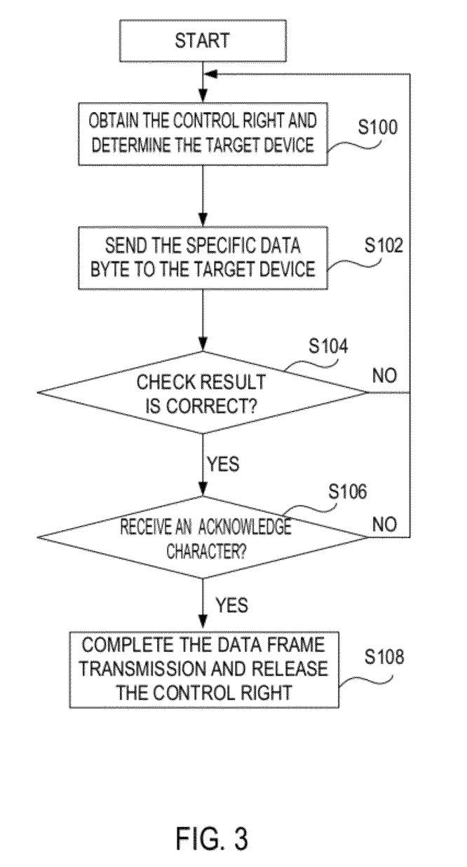

FIG. 3 shows a flowchart of a method for transmitting data, in accordance with one embodiment of the present invention. At step S100, the battery management system 1 or an associated device sends a frame header of a data frame to obtain a control right of the one-wire bi-directional communication line, and determine a target device of the data frame. For illustrative purposes, an “associated device” in the present invention refers to the devices outside the battery management system 1, which can communicate with the battery management system 1, such as the battery charger 3, the electric vehicle controller 4, the monitor 5, and other associated devices 6 in FIG. 1 and FIG. 2. In addition, a device which transmits the data frame is referred to as a source device, while a device which receives the data frame is referred to as a target device. The source device can be the battery management system 1 or an associated device. Correspondingly, the target device can be an associated device (e.g., the battery charger 3, the electric vehicle controller 4, the monitor 5, and other associated devices 6) or the battery management system 1.

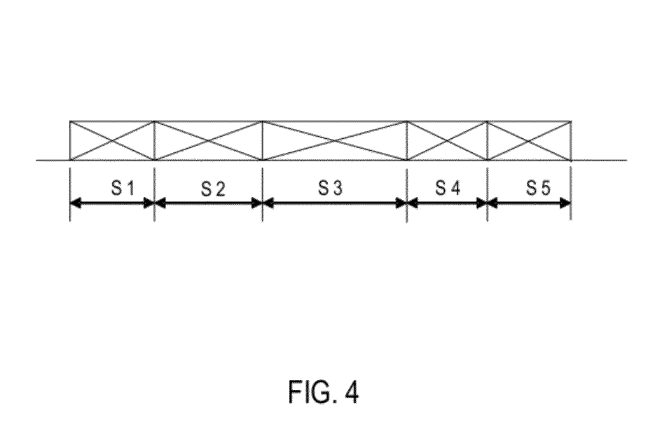

In one embodiment of the present invention, the data transmitted via a one-wire bi-directional communication line between the battery management system 1 and an associated device is in the form of multiple data frames. In one such embodiment, the structure of a data frame is showed in FIG. 4.

As shown in the embodiment in FIG. 4, a data frame includes portions S1-S5. Portions S1 and S2 constitute a frame header. More specifically, S1 represents a sync header which indicates a source device and a target device in the data transmission. S2 represents a data indicator which indicates the type of a specific data byte in the data frame. S3 represents the specific data byte. S4 represents a checksum. S5 represents an acknowledge character (ACK).

In one embodiment, the minimum unit of the data frame transmitted via the one-wire bi-directional communication line is one binary bit (Bit 1 or Bit 0). In one such embodiment, Bit 1 and Bit 0 are defined as follows.

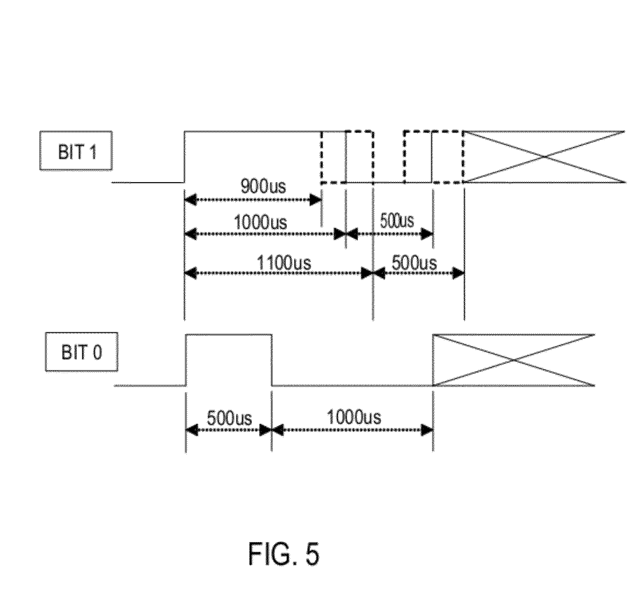

A Bit 1 drives the one-wire bi-directional communication line to logic high, and maintains logic high for a first predetermined time period. Then, the Bit 1 drives the one-wire bi-directional communication line to logic low and maintains logic low for a second predetermined time period. The first predetermined time period is longer than the second predetermined time period, in one embodiment. A Bit 0 drives the one-wire bi-directional communication line to logic high and maintains logic high for a third predetermined time-period. Then, the Bit 0 drives the one-wire bi-directional communication line to logic low, and maintains logic low for a fourth predetermined time period. The third predetermined time period is less than the fourth predetermined time period. FIG. 5 shows an example of the waveform of Bit 1 and Bit 0 in a data frame, in accordance with one embodiment of the present invention. In the example of FIG. 5, if the status of the one-wire bi-directional communication line remains logic high for 1000 (+/−100) μs and then remains logic low for 500 (+/−100) μs, it represents a Bit 1. If the status of the one-wire bi-directional communication line remains logic high for 500 (+/−100) μs and then remains logic low for 1000 (+/−100) μs, it represents a Bit 0. In the example above, the first predetermined time-period is 1000 (+/−100) μs, the second predetermined time-period is 500 (+/−100) μs, the third predetermined time-period is 500 (+/−100) μs, and the fourth predetermined time-period is 1000 (+/−100) μs. Furthermore, in the example above, the timing tolerance of Bit 1 and Bit 0 are both 10%.

In one embodiment, the frame header includes a sync header S1 which indicates a source device and a target device in the data transmission. More specifically, the sync header includes a control flag indicating a control right of the one-wire bi-directional communication line and a type flag indicating a type of an associated device.

Table 1 below shows examples of the sync header and corresponding meanings. In one embodiment, the sync header includes three bits, wherein the first bit indicates the source device of the data transmission (i.e., the control flag indicating a control right of the one-wire bi-directional communication line). The next two bits indicate the type of the associated device.

For example, if the sync header is 100, the Bit 1 of the first bit represents that the source device is the battery management system (BMS) 1. That is, the battery management system 1 obtains the control right of the one-wire bi-directional communication line and sends the data to the associated device. The “00” of the next two bits indicates that the type of the associated device is a battery charger (CCS) 3. In other words, the sync header “100” represents that the data transmission is from the battery management system 1 to the battery charger 3.

In another example, if the sync header is 000, the Bit 0 of the first bit represents that the source device is an associated device. That is, the associated device obtains the control right of the one-wire bi-directional communication line and sends data to the battery management system 1. The “00” of the next two bits indicates that the associated device which obtains the control right is the battery charger 3. In other words, the sync header “000” represents that the data transmission is from the battery charger 3 to the battery management system 1.

Consequently, the source device and the target device can be determined by the sync header, and thus the direction of the data transmission can be determined. Accordingly, the transmission direction of the acknowledge character can also be determined, which is the opposite direction of the data transmission.

TABLE 1

| Sync | Data Transmission | Acknowledge Character |
|---|---|---|
| header | Direction | Transmission Direction |
| 100 | BMS → CCS | CCS → BMS |
| 000 | CCS → BMS | BMS → CCS |
| 101 | BMS → PC | PC → BMS |
| 001 | PC → BMS | BMS → PC |
| 110 | BMS → EB | EB → BMS |
| 010 | EB → BMS | BMS → EB |
| 111 | Reserved | Reserved |
| 011 | Reserved | Reserved |

As shown in Table 1, in one embodiment, the type flag of associated devices includes two bits, for example, “00” represents that the associated device is the battery charger (CCS) 3, “01” represents that the associated device is the monitor (PC) 5, “10” represents that the associated device is the electric vehicle controller (EB) 4, and “11” is reserved for other devices 6 according to specific applications. In other embodiments, the type flag can include more bits to represent or reserve for other devices.

In one embodiment according to the present invention, the battery management system 1 is assigned to obtain the control right of the communication line, when both the battery management system 1 and the associated device require the control right of the communication line simultaneously.

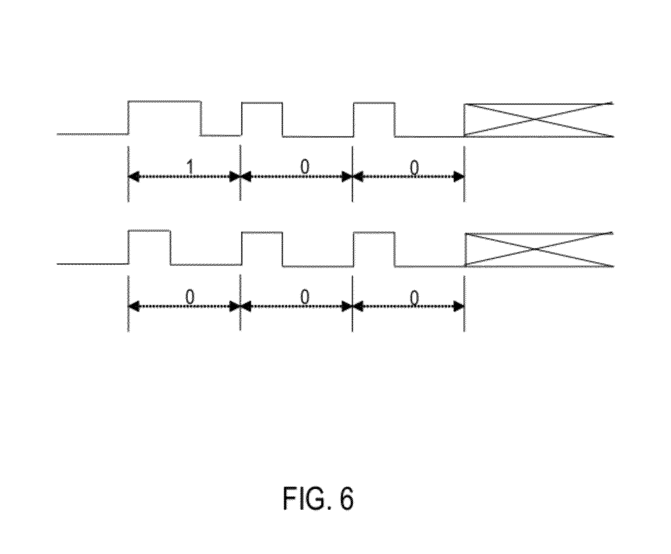

FIG. 6 shows a first waveform of a sync header in a first data frame and a second waveform of a sync header in a second data frame, in accordance with one embodiment of the present invention. The sync header 100 in the first data frame indicates that the first data frame is transmitted from the battery management system 1 to the battery charger 3. The sync header 000 in the second data frame indicates that the second data frame is transmitted from the battery charger 3 to the battery management system 1. Furthermore, in one embodiment, if both the battery management system 1 and the battery charger 3 require a control right of the communication line simultaneously, the battery management system 1 obtains the control right.

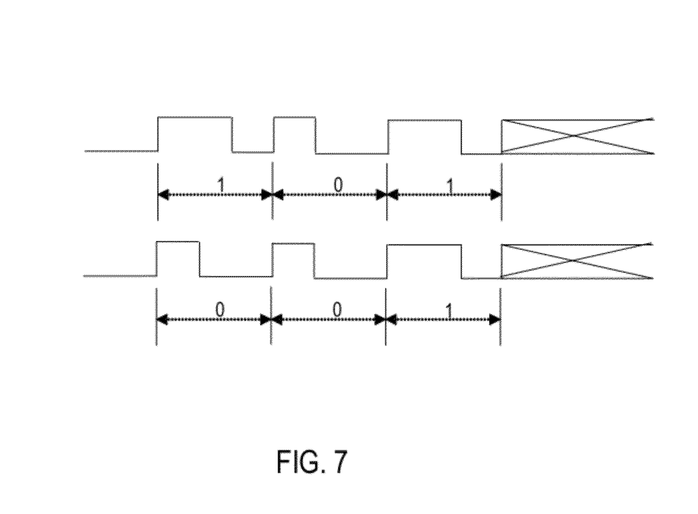

FIG. 7 shows a third waveform of a sync header in a third data frame and a fourth waveform of a sync header in a fourth data frame, in accordance with one embodiment of the present invention. The sync header 101 in the third data frame indicates that the third data frame is transmitted from the battery management system 1 to the monitor 5. The sync header 001 in the fourth data frame indicates that the fourth data frame is transmitted from the monitor 5 to the battery management system 1. Furthermore, in one embodiment, if both the battery management system 1 and the monitor 5 require a control right of the communication line, the battery management system 1 obtains the control right simultaneously.

In addition, the frame header further includes the portion S2 as shown in FIG. 4, which includes a data indicator for indicating the type of a specific data byte in the data frame. In one embodiment, S2 includes 5 bits. Table 2 shows examples of the data indicator represented by S2.

TABLE 2

| S2 (Bit 4-Bit 0) | Data indicator |
|---|---|
| 00000 | Charging Phase |
| 00001 | Battery Status Flags |
| 00010 | Voltage Value Data High |
| 00011 | Voltage Value Data Low |
| 00100 | Current Value Data High |
| 00101 | Current Value Data Low |
| 00110-11111 | Reserved |

In one embodiment, the portion S3 represents the specific data byte which occupies 8 bits. Table 3 shows examples of the specific data byte represented by S3 and is described in combination with Table 2. For example, as shown in table 2 and table 3, if the data indicator in S2 is “00000” and the specific data byte in S3 is “00000000” (0x00), it represents that the charging is in idle. If the data indicator in S2 is “00000” and the specific data byte in S3 is “00000110” (0x06), it represents that the charging is over. For another example, if the data indicator in S2 is “00001” and the specific data byte is “10000000”, it represents that the charging is forbidden. If the data indicator in S2 is “00001” and the specific data byte is “01000000”, it represents that the battery is undergoing an under-temperature condition. For yet another example, the battery management system 1 monitors a voltage level of the battery and a current level of a charging current. The voltage level is digitized to generate a 16-bit digital value which represents a voltage level between 0-65.535V. The current level is digitized to generate a 16-bit digital value which represents a current level between 0-65.535 A. If the data indicator in S2 is “00010”, it indicates that the 8-bit content of the specific data byte is the first byte (Bit15 to Bit8) of the 16-bit digitized voltage level. If the data indicator in S2 is “00101”, it indicates that the 8-bit content of the specific data byte is the second byte (Bit7 to Bit0) of the 16-bit digitized current level.

TABLE 3

| NAME | SEPCIFIC CONTENTS |
|---|---|
| Charge Phase | 0x00: Idle |
| | 0x01: Pre-charge |
| | 0x02: Constant Current Charge |
| | 0x03: Constant Voltage Charge |
| | 0x04: Pulse Charge |
| | 0x05: Floating Charge |
| | 0x06: Charging End |
| Battery Status Flags (8-bit) | Bit7: Charge Permission Flag |
| | 0-Allow 1-Forbid |
| | Bit6: Battery Under-Temperature |
| | 0-Normal 1- Under-Temperature |
| | Bit5: Battery Over-Temperature |
| | 0-Normal 1- Over-Temperature |
| | Bit4: Cell Under-Voltage |
| | 0-Normal 1- Under-Voltage |
| | Bit3: Cell Over-Voltage |
| | 0-Normal 1- Over-Voltage |
| | Bit2: Cell High Voltage |
| | 0-Normal 1- High Voltage |
| | Bit1: Reserved |
| | Bit0: Reserved |
| Voltage Value Data High (8-bit) | 16 bit |
| Voltage Value Data Low (8-bit) | LSB: 1 mV/bit range: 0-65.535 V |
| Current Value Data High (8-bit) | 16 bit |
| Current Value Data Low | (8-bit) LSB: 1 mV/bit |
| | range: 0-65.535 A |

Referring back to FIG. 3, at step S102, the battery management system 1 or the associated device sends the specific data byte to the target device. Taking the structure of the data frame in FIG. 4 as an example, at step S102, the battery management system 1 or the associated device sends the specific data byte in portion S3 to the target device.

At step S104, the target device checks the data frame. If the check result is correct, the data frame transmission is successful. If the check result is incorrect, the flowchart returns to the step S100 to resend the data frame. More specifically, according to the data frame structure in the example of FIG. 4, the following method for checking the data frame according to one embodiment of present invention can be employed. First, the source device merges the control flag, the type flag and the type of specific data byte. That is, the source device combines the 3-bit sync header and the 5-bit data indicator to an 8-bit combination. Second, the source device performs an exclusive or (XOR) operation on the 8-bit combination and the 8-bit specific data byte and sends the result of the XOR operation (i.e., the checksum) to the target device in portion S4 of the data frame. Third, the target device performs similar operation to the received data frame, e.g., merges the received 3-bit sync header and the 5-bit data indicator, and performs the XOR operation on the 8-bit combination and the received 8-bit specific data byte. The target device compares the received checksum in the portion S4 with the operation result. If the received checksum is equal to the operation result, the communication is successful, the received data frame is correct. Then, the target device returns an acknowledge character (ACK) to the source device. Otherwise, it means that the data is changed during the transmission, and the received data frame is incorrect. As such, no acknowledge character is returned from the target device.

At step S106, the source device checks whether an acknowledge character is received from the target device within a predetermined time, e.g., 2 ms. If yes, then the transmission of the data frame is completed, and the source device releases the control right of the one-wire bi-directional communication line, as described at step S108. Otherwise, it is assumed that an abnormal condition occurs during the transmission, such as communication time-out, abnormal communication, or data error, and the flowchart returns to the step S100 to resend the data frame.

If all the contents of the data frame, e.g. from S1 to S5, have been transmitted on the one-wire bi-directional communication line, it indicates that this transmission is completed and the next transmission can be started.

According to the data frame structure described above, the data frame can be defined with flexibility, which enhances the security of transmission.

Before transmitting data, the source device detects the status of the communication line. If the status remains logic high, it means that no device is connected to the one-wire bi-directional communication line. If a transition from logic high to logic low is detected and then the status remains logic low for more than a predetermined time, e.g., 2 ms, the source device determines that at least one device is connected to the communication line.

Moreover, after one device is detected to be connected to the one-wire bi-directional communication line, the source device further detects whether the one-wire bi-directional communication line is free. The data transmission can be carried out if the communication line is free. In one embodiment, after the source device determines that at least one device is connected to the communication line, if the status of the communication line is logic low and remains low for more than a predetermined time, e.g., 2 ms, the source device determines that the communication line is free, and a data frame can be transmitted according to the flowchart described in relation to FIG. 3. Otherwise, the source device waits until the communication line is free. In one embodiment, the source device sends a logic low to release the control right of the one-wire bi-directional communication line after each data frame transmission is completed.

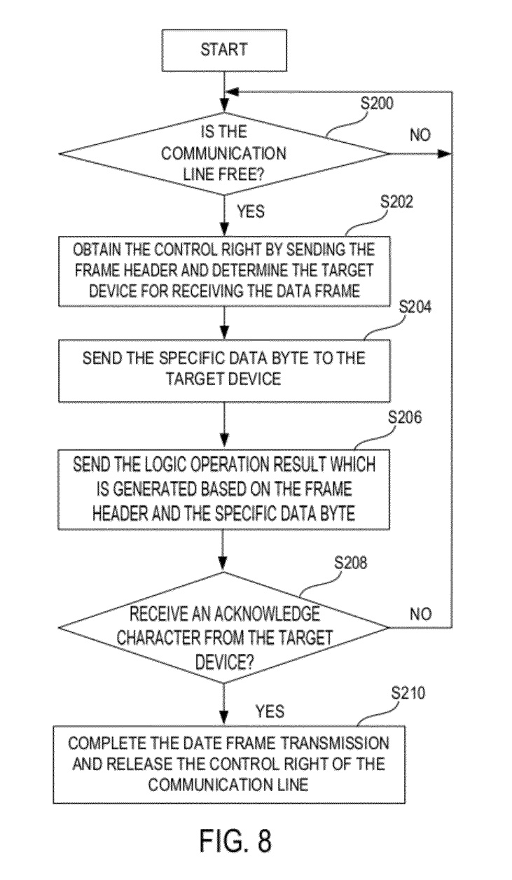

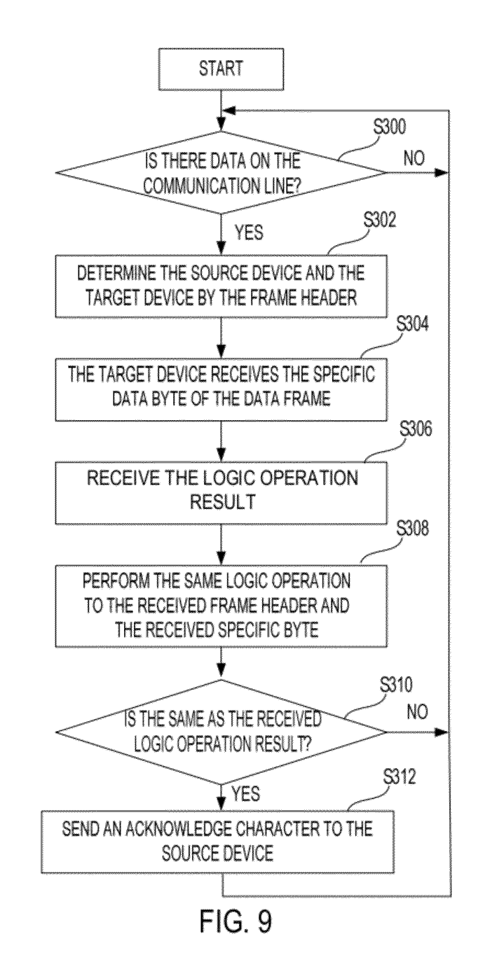

According to the description above and the flowchart shown in FIG. 3, the data transmission on the one-wire bi-directional communication line involves sending data and receiving data, which are described in FIG. 8 and FIG. 9 respectively.

FIG. 8 shows a flowchart illustrating the sending operation. At the beginning of the data transmission, at step S200, a source device detects whether the one-wire bi-directional communication line is free. If the communication line is free, the source device obtains the control right of the one-wire bi-directional communication line by sending the frame header and determines the target device, at step S202. If the communication line is not free, the source device keeps detecting until it is free. At step S204, the source device sends the specific data byte in the data frame to the target device. At step S206, the source device sends the logical operation result which is generated based on the frame header of the data frame and the specific data byte. At step S208, the source device checks whether an acknowledge character from the target device is received. At step 210, if the acknowledge character is received, the source device completes the sending of the data frame and releases the control right of the one-wire bi-directional communication line.

FIG. 9 shows a flowchart illustrating the receiving operation. At the beginning of the data transmission, at step S300, the battery management system 1 and the associated devices check whether there is data being transmitted on the one-wire bi-directional communication line. If yes, the source device and the target device are determined according to the sync header in the frame header of the data frame, at step S302. At step S304, the target device receives the specific data byte. At step S306, the target device receives the logic operation result which is generated based on the frame header and the specific data byte. At step S308, the target device performs the logic operation to the received frame header and the received specific data byte. At step S310, the target device determines whether the result of logic operation is the same as the received logic operation result. If yes, the flowchart goes to step S312 where the target device sends an acknowledge character to the source device and the flowchart returns to step S300. Otherwise, the flowchart skips the step S312 and returns to step S300 directly.

Embodiments above illustrate data transmission between a battery management system 1 and an associated device though a one-wire bi-directional communication line. In operation, the battery management system 1 can communicate with multiple associated devices. In one embodiment, each associated device can be set with a corresponding communication priority. Accordingly, when two or more associated devices require communications with the battery management system 1 simultaneously, the data transmission can be conducted based on the predetermined communication priority of each associated device.

In addition, when a new associated device is coupled to the communication line, the battery management system 1 can be notified by detecting the status of the communication line. Similarly, the communication priorities of the new associated devices and the existing associated devices can be updated. Therefore, each associated device can communicate with the battery management system 1 according to the communication priorities.

If there is no associated device coupled to the battery management system 1 via the communication line, the status of the communication line remains logic high. If there is one or more associated device coupled to the battery management system 1 via the communication line, the status of the communication line changes to logic low after a data transmission is completed, which indicates that the status of the communication line is free to start another data transmission.

Advantageously, the present invention can utilize the idle terminal of the current standard connector to conduct data communication, thereby reducing the cost.

While the foregoing description and drawings represent embodiments of the present invention, it will be understood that various additions, modifications and substitutions may be made therein without departing from the spirit and scope of the principles of the present invention as defined in the accompanying claims. One skilled in the art will appreciate that the invention may be used with many modifications of form, structure, arrangement, proportions, materials, elements, and components and otherwise, used in the practice of the invention, which are particularly adapted to specific environments and operative requirements without departing from the principles of the present invention. The presently disclosed embodiments are therefore to be considered in all respects as illustrative and not restrictive, the scope of the invention being indicated by the appended claims and their legal equivalents, and not limited to the foregoing description.

What is claimed is:

1. A method for transmitting a data frame between a battery management system (BMS) and an associated device, wherein said battery management system is coupled to said associated device via a one-wire bi-directional communication line, said method comprising:
obtaining a control right of said one-wire bi-directional communication line and determining a target device based on a frame header by sending said frame header of said data frame by a source device;
sending a specific data byte of said data frame from said source device to said target device;
checking whether an acknowledge character from said target device is received by said source device within a predetermined time period; and
releasing said control right of said one-wire bi-directional communication line if said the acknowledge character is received within said predetermined time period by said source device and resending said data frame if no acknowledge character is received by said source device within said predetermined time period.

2. The method of claim 1, wherein a minimum unit of said data frame transmission is one binary bit.

3. The method of claim 2, wherein said data bit comprises Bit 1 and Bit 0.

4. The method of claim 3, wherein said Bit 1 drives said one-wire bi-directional communication line to logic high and maintains said logic high for a first predetermined time-period, and then said Bit 1 drives said one-wire bi-directional communication line to logic low and maintains said logic low for a second predetermined time-period, wherein said Bit 0 drives said one-wire bi-directional communication line to logic high and maintains said logic high for a third predetermined time-period, and then said Bit 0 drives said one-wire bi-directional communication line to logic low and maintains said logic low for a fourth predetermined time-period.

5. The method of claim 1, wherein said frame header comprises a sync header that indicates said source device and said target device of said data transmission.

6. The method of claim 5, wherein said frame header further comprises a data indicator that indicates a type of said specific data byte in said data frame.

7. The method of claim 1, further comprising:
checking said data frame.

8. The method of claim 7, wherein said step of checking said data frame comprises:
performing a logic operation based on said frame header and said specific data byte by said source device to generate a first operation result, and sending said first operation result to said target device after sending said specific data byte;
performing said logic operation based on a received frame header of and a received specific data byte by said target device to generate a second operation result;
checking whether said first operation result equals to said second operation result; and
sending an acknowledge character to said source device from said target device if said first operation result equals to said second operation result.

9. The method of claim 1, further comprising:
assigning said control right to said battery management system if said battery management system and said associated device both require said control right simultaneously.

10. The method of claim 1, further comprising:
assigning communication priorities to a plurality of associated devices respectively based on a predetermined priority rule if said battery management system is coupled to said plurality of associated devices via said one-wire bi-directional communication line; and
transmitting said data frame between said associated devices and said battery management system according to said communication priorities.

11. The method of claim 1, wherein said associated device is selected from the group consisting of a battery charger, a monitor and an electric vehicle controller.

12. The method of claim 10, further comprising:
determining whether a new associated device is coupled to said one-wire bi-directional communication line;
determining communication priorities of said new associated device and said plurality of associated devices for data transmission with said battery management system respectively.
